(19) United States
(12) Patent Application Publication
(10) Pub. No.: US 2009/0029117 A1
(43) Pub. Date: Jan. 29, 2009

(54) COMPOSITE LENS

(75) Inventors: Yuma Aoi, Hirakata-shi (JP); Youhei Nakagawa, Neyagawa-shi (JP)

Correspondence Address: OCCHIUTI ROHLICEK & TSAO, LLP, 10 FAWCETT STREET, CAMBRIDGE, MA, 02138, US

(73) Assignee: Sanyo Electric Co., Ltd, Moriguchi-shi (JP)

(21) Appl. No.: 12/178,799

(22) Filed: Jul. 24, 2008

(30) Foreign Application Priority Data
Jul. 26, 2007 (JP) 2007-194388

(51) Int. Cl. B32B 23/00

(52) U.S. Cl. 428/192

(57) ABSTRACT

A composite lens that prevents insufficient hardening of an ultraviolet curable resin near the periphery of an optically effective portion. The composite lens includes a plastic lens and a resin layer. The plastic lens includes the optically effective portion and a flange surrounding the optically effective portion. The resin layer is formed from an ultraviolet curable resin and arranged in contact with the optically effective portion. The flange includes a diffusion portion which diffuses ultraviolet light irradiating the plastic lens toward the resin layer through the plastic lens.

### CROSS-REFERENCE TO RELATED APPLICATIONS

This application is based upon and claims the benefit of priority from the prior Japanese Patent Application No. 2007-194388, filed on Jul. 26, 2007, the entire contents of which are incorporated herein by reference.

### BACKGROUND OF THE INVENTION

The present invention relates to a composite lens, and more particularly, to a composite lens suitable for use in a compact image capturing device.

A composite lens, which corrects aberration with a single lens, is formed from material having different refractive indexes. A composite lens that is formed by depositing light transmissible resin on an optically effective surface of a lens is widely used. Japanese Laid-Open Patent Publication Nos. 62-227711 and 5-34509 describe methods for manufacturing a composite lens by using a glass lens as the base material of the composite lens and an ultraviolet curable resin as the deposited resin.

The formation of the prior art composite lens will now be discussed. An injection molded plastic lens is used as the lens that serves as the base material. An ultraviolet curable resin is used to form a resin layer. The resin layer is formed by molding ultraviolet curable resin and hardening the molded resin with ultraviolet rays.

The plastic lens is formed through injection molding. Thus, an annular flange having a uniform thickness is formed outwards from an optically effective portion. Ultraviolet curable resin is then charged into a gap between the plastic lens and a mold. The resin is then pressurized to form the resin layer. Subsequently, as shown in FIG. 1(a), the side of the lens 1 that is distant from the mold 3, that is, the side opposite the resin layer, is irradiated with ultraviolet light 41. The plastic lens 1 is uniformly irradiated with the ultraviolet light 41. The ultraviolet light 41 is refracted by the plastic lens 1 before reaching the ultraviolet curable resin 2. When a convex lens is formed by the optically effective portion of the plastic lens 1 (in FIG. 1(b), the portion corresponding to x=−0.9 to +0.9), the optically effective portion refracts the ultraviolet light 41, which is formed by parallel light rays. This converges the ultraviolet light 41 in the direction of the optical axis. The ultraviolet light 41 irradiating the flange of the plastic lens 1 is not refracted and thus continues to travel straight. As a result, the intensity of the ultraviolet light 41 after passing through the plastic lens 1 becomes maximum near the optical axis and gradually decreases toward the periphery of the optically effective portion. The intensity is minimum at the part of the optically effective portion in the plastic lens 1 that is near the flange (in FIG. 1(b), the positions corresponding to x=±0.8). The intensity increases again from the flange (in FIG. 1(b), the portions corresponding to x<−0.9 and x>+0.9) and then becomes constant. The ultraviolet light irradiating parts of the optically effective portion that is located near the flange of the plastic lens is refracted in the direction of the optical axis. However, the ultraviolet light irradiating the flange is not directed toward the optical axis.

As a result, in the optically effective portion of the plastic lens, the ultraviolet light that reaches the ultraviolet curable resin near the flange is insufficient. This is problematic in that the hardening of the ultraviolet curable resin at this part becomes insufficient.

### SUMMARY OF THE INVENTION

The present invention provides a composite lens that prevents insufficient hardening of the ultraviolet curable resin near the periphery of the optically effective portion by irradiating the part of the optically effective portion in the plastic lens located near the flange with sufficient ultraviolet light.

One aspect of the present invention is a composite lens including a plastic lens and a resin layer. The plastic lens includes an optically effective portion and a flange surrounding the optically effective portion. The resin layer is formed from an ultraviolet curable resin and arranged in contact with the optically effective portion. The flange includes a diffusion portion which diffuses ultraviolet light irradiating the plastic lens toward the resin layer through the plastic lens.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a cross-sectional view showing a prior art composite lens irradiated with ultraviolet light along a plane including an optical axis, and

FIG. 1(b) is a graph showing the amount of ultraviolet light passing through a plastic lens;

FIG. 2(a) is a cross-sectional view showing a composite lens according to a first embodiment of the present invention along a plane including an optical axis, and

FIG. 2(b) is a plan view taken from an ultraviolet light irradiation direction;

FIG. 3(a) is a cross-sectional diagram showing the composite lens of the first embodiment irradiated with ultraviolet light along a plane including the optical axis, and

FIG. 3(b) is a graph showing the amount of ultraviolet light passing through a plastic lens;

FIG. 4(a) is a cross-sectional view showing the composite lens of the first embodiment along a plane including the optical axis, and FIG. 4(b) is a graph comparing resin surface shape difference with the prior art composite lens;

FIG. 5(a) is a cross-sectional view showing a composite lens according to a second embodiment of the present invention along a plane including an optical axis, and

FIG. 5(b) is a plan view taken from an ultraviolet light irradiation direction;

FIG. 6(a) is a cross-sectional view showing a composite lens according to a third embodiment of the present invention along a plane including an optical axis, and

FIG. 6(b) is a plan view taken from an ultraviolet light irradiation direction;

FIG. 7 is a partially enlarged view of FIG. 6(a) showing the composite lens of the third embodiment irradiated with ultraviolet light; and

FIG. 8(a) is a cross-sectional view showing a composite lens according to a fourth embodiment of the present invention along a plane including an optical axis, and

FIG. 8(b) is a partially enlarged view of FIG. 8(a).

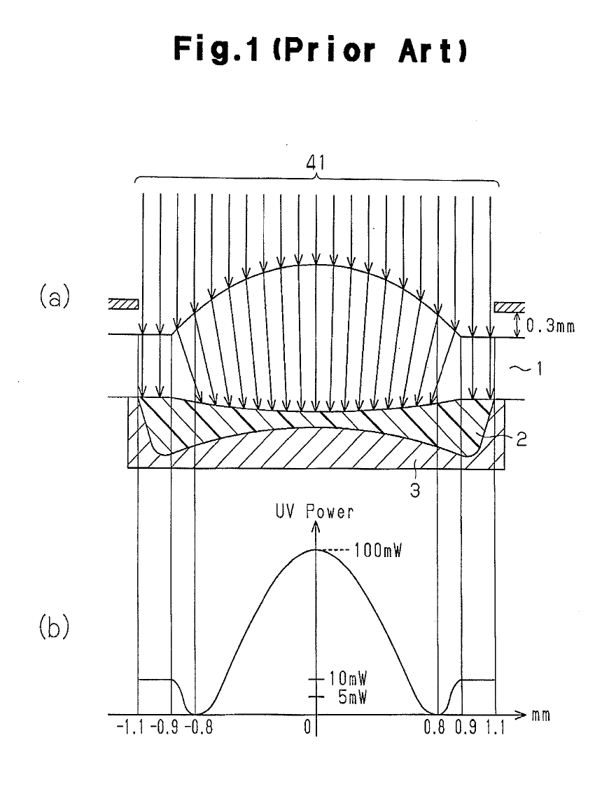

### DETAILED DESCRIPTION OF THE PREFERRED EMBODIMENTS

In the drawings, like numerals are used for like elements throughout.

### First Embodiment

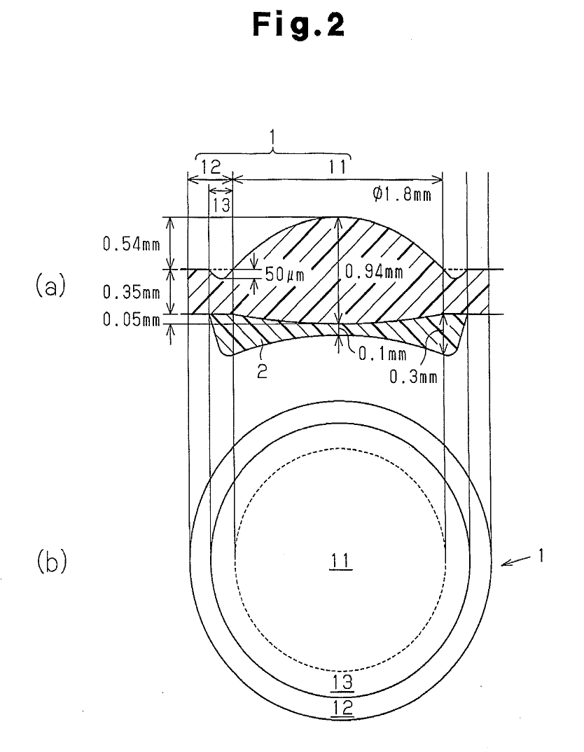

A composite lens according to a first embodiment of the present invention will now be discussed with reference to FIGS. 2 to 4. The composite lens may be used as various types of optical lenses, such as an image capturing lens. The composite lens is especially useful when applied as a lens for a compact image capturing device or an optical reading device.

Referring to FIG. 2, the composite lens of the first embodiment includes a plastic lens 1, which serves as a base material, and an ultraviolet curable resin 2, which is in contact with one side of an optically effective portion 11 of the plastic lens 1. The plastic lens is formed by injection molding a transparent resin. Although not particularly limited, it is desirable that the transparent resin be ZEONEX E48R manufactured by Zeon Corporation. The plastic lens 1 is a convex lens, with the optically effective portion 11 having a center thickness of 0.94 mm and an optically effective diameter of 1.80 mm. Further, the plastic lens 1 includes an annular flange 12 having a thickness of 0.35 mm and surrounding the optically effective portion 11. An annular round groove 13 is formed in the flange 12 around the optically effective portion 11. The round groove 13 functions as a diffusion portion for diffusing the irradiated ultraviolet light toward the resin layer formed by the ultraviolet curable resin 2. Further, the round groove 13 has a width of 200 μm and a depth of 50 μm. The flange 12 has a uniform thickness of 0.35 mm excluding the part where the round groove 13 is formed.

The ultraviolet curable resin 2, which is in contact with one side of the plastic lens 1, forms a resin layer functioning as a concave lens having a center thickness of 0.10 mm. In the ultraviolet curable resin 2, the part corresponding to the optically effective portion 11 of the plastic lens 1 has a maximum thickness of 0.30 mm. The ultraviolet curable resin 2 is not particularly limited as long as it is transparent and hardened when irradiated with ultraviolet light. However, it is desirable that the ultraviolet curable resin 2 be MP202 manufactured by Mitsubishi Rayon Co., Ltd.

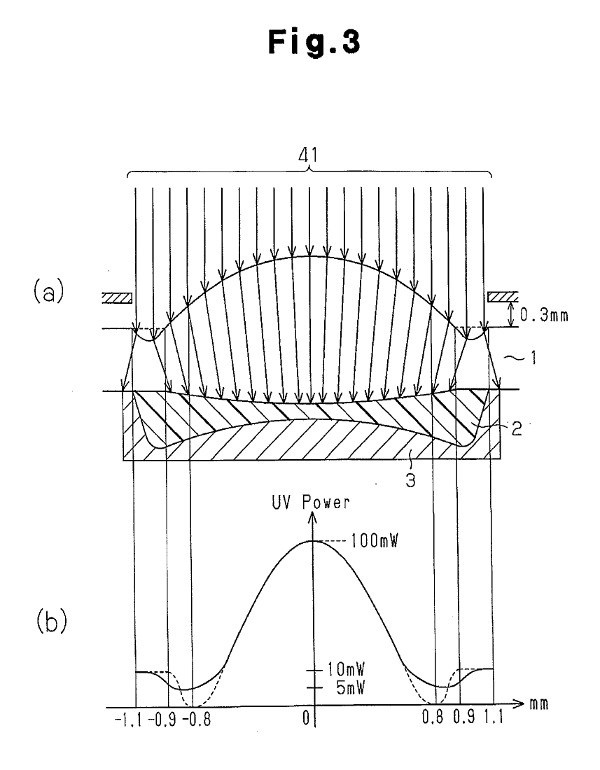

Referring to FIG. 3(a), a predetermined amount of a gel of the ultraviolet curable resin 2 is charged into a mold 3. Then, the mold 3 is closed with the plastic lens 1. This fills the gap defined by the mold 3 and the plastic lens 1 with the gel of the ultraviolet curable resin 2 and forms a resin layer. Further, the ultraviolet curable resin 2 is irradiated with ultraviolet light and hardened. Afterwards, the mold 3 is removed to complete production of the composite lens.

An irradiation path for the ultraviolet light will now be described in detail with reference to FIGS. 3(a) and 3(b).

In FIG. 3(b), the horizontal axis (x axis) represents radial positions on the composite lens, and the vertical axis (y axis) represents intensity of the ultraviolet light that has passed through the plastic lens 1. The origin (zero point) of the horizontal axis (x axis) is located at a point at which the optical axis of the composite lens intersects with the horizontal axis (x axis). To facilitate understanding, the horizontal axis (x axis) is shown in FIG. 3(b) in correspondence with FIG. 3(a).

As shown in FIG. 3(a), the plastic lens 1 is irradiated with ultraviolet light 41 from the side opposite the surface that is in contact with the ultraviolet curable resin 2. The ultraviolet curable resin 2 is in contact with the mold 3. Thus, the ultraviolet curable resin 2 is not directly irradiated with the ultraviolet light 41. The ultraviolet light 41 is formed by light rays parallel to the optical axis of the plastic lens 1. Thus, the ultraviolet light 41 irradiates the surface of the plastic lens 1 with a uniform intensity. The plastic lens 1 refracts the ultraviolet light 41 irradiating the optically effective portion 11 and converges the ultraviolet light 41 in the direction of the optical axis (i.e., the direction of X=0). Thus, after passing through the plastic lens 1, the intensity of the ultraviolet light 41, that is, the intensity of the ultraviolet light 41 reaching the ultraviolet curable resin 2 becomes maximum near the optical axis of the plastic lens 1 and gradually decreases toward the peripheral portion. The ultraviolet light 41 irradiating the flange 12 of the plastic lens 1 at parts excluding the round groove 13 is not refracted by the plastic lens 1 and thus continues to travel straight. Therefore, the ultraviolet light 41 that has passed through the flange 12 has a uniform intensity and is proportional to the intensity of the ultraviolet light 41 before passing through the flange 12. Further, the ultraviolet light 41 irradiating the round groove 13 in the flange 12 of the plastic lens 1 is refracted and diffused by the plastic lens 1. Some of the diffused light is directed toward the optically effective portion 11. This increases the ultraviolet light intensity near the periphery of the optically effective portion 11 in the composite lens of the first embodiment, which is shown by the solid lines in FIG. 3(b), compared with the ultraviolet light intensity in the prior art, which is shown by the broken lines in FIG. 3(a). Further, the region in which the ultraviolet light intensity is minimum is moved in the peripheral direction from the position where the intensity is minimum in the prior art (i.e., the position corresponding to X=±0.8). This prevents insufficient hardening of the ultraviolet curable resin 2 near the periphery of the part contacting the optically effective portion 11.

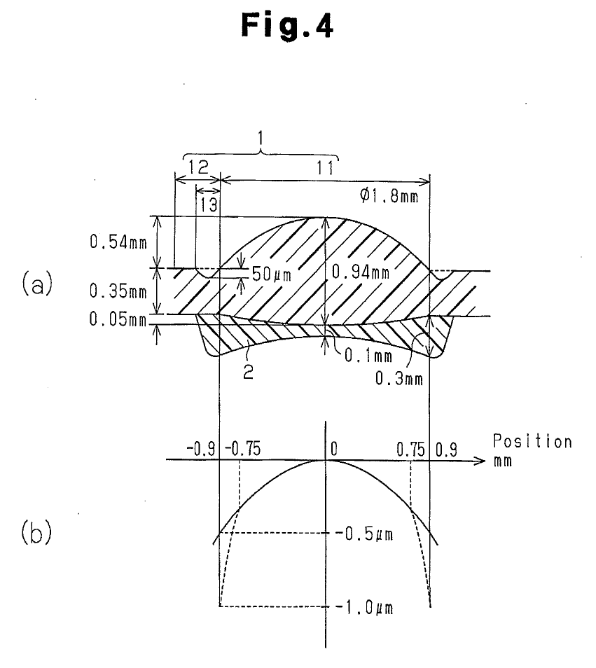

The effect of the round groove 13 in the first embodiment will now be discussed with reference to FIGS. 4(a) and 4(b).

FIG. 4(b) is a diagram comparing variations in the thickness of the resin layer between the first embodiment and the prior art. In FIG. 4(b), the horizontal axis (x axis) represents radial positions on the composite lens, and the vertical axis (y axis) represents the difference between the actually measured thickness and the designed thickness of the resin layer (hereafter, referred to as the “resin surface shape difference”). The origin (zero point) of the horizontal axis (x axis) is located at a point at which the optical axis of the composite lens intersects with the horizontal axis (x axis). To facilitate understanding, the horizontal axis (x axis) is shown in FIG. 4(b) in correspondence with FIG. 4(a). To measure the resin layer thickness, NH-3SP, which is a non-contact three-dimensional measurement device manufactured by Mitaka Kohki Co., Ltd. was used, and the thickness was measured for a range extending 0.9 mm from the center point in opposite directions (optically effective radius range).

As is apparent from FIG. 4(b), in comparison with the resin surface shape difference of the prior art shown by the broken line, the resin surface shape difference of the first embodiment shown by the solid line is smaller especially near the periphery of the optically effective portion 11 (i.e., positions outward from the position corresponding to x=±0.75). This shows that in the composite lens of the prior art, insufficient hardening of the ultraviolet curable resin near the periphery of the optically effective portion resulted in insufficient accuracy subsequent to hardening. In other words, the first embodiment prevents insufficient hardening and increases accuracy subsequent to hardening.

The composite lens of the first embodiment has the advantages described below.

(1) The round groove 13 in the flange 12 diffuses the irradiated ultraviolet light. This increases the intensity of the ultraviolet light that irradiates the ultraviolet curable resin 2, which is in contact with the optically effective portion 11. Accordingly, the ultraviolet light intensity near the periphery of the optically effective portion 11 is prevented from decreasing. As a result, insufficient hardening at this part of the ultraviolet curable resin 2 is prevented.

Further, as shown in FIGS. 4(a) and 4(b), the resin surface shape difference at the part near the periphery of the optically effective portion of the composite lens is improved. Thus, the thickness of the ultraviolet curable resin 2 is close to the designed value.

(2) The round groove 13 is annular and surrounds the optically effective portion 11. Thus, the ultraviolet light diffused by the round groove 13 reaches parts near the entire periphery of the optically effective portion 11.

(3) The advantages described above are obtained just by forming the round groove 13 in the flange 12. The round groove 13 can be formed at the same time as when injection molding the plastic lens 1. This simplifies production of the composite lens and lowers costs.

### Second Embodiment

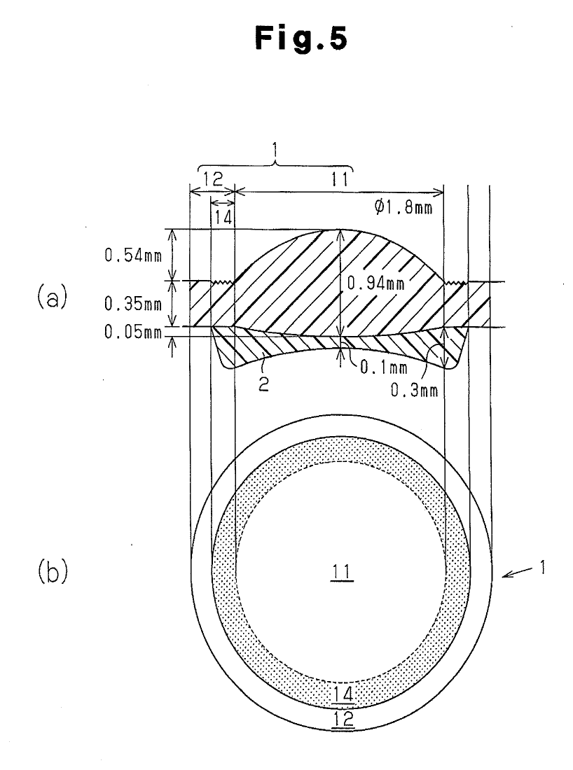

A composite lens according to a second embodiment of the present invention will now be discussed with reference to FIGS. 5(a) and 5(b). The second embodiment differs from the first embodiment only in the structure of the flange 12. Parts that are the same as the first embodiment will not be described.

As shown in FIGS. 5(a) and 5(b), the flange 12 of the second embodiment includes an annular embossed surface 14, which includes pits and lands and which surrounds the optically effective portion 11. The embossed surface 14 functions as a diffusion portion for diffusing the irradiated ultraviolet light toward the resin layer. The embossed surface 14 has a width of 200 μm and a centerline average roughness Ra of 0.5 μm or greater. To diffuse ultraviolet light, it is desirable that the roughness Ra be greater than the median wavelength of the ultraviolet light (365 nm). The embossed surface 14 may be formed when injection molding the plastic lens 1 or by using a chemical agent after the injection molding to cause erosion in the surface of the plastic lens 1.

The second embodiment has the advantages described below.

(1) The embossed surface 14 in the flange 12 diffuses the irradiated ultraviolet light. As a result, some of the diffused ultraviolet light reaches the ultraviolet curable resin 2 contacting the optically effective portion 11. This increases the intensity of the ultraviolet light irradiating the ultraviolet curable resin 2 that is in contact with the optically effective portion 11 in comparison with the prior art. Accordingly, the intensity of the ultraviolet light near the periphery of the optically effective portion 11 is prevented from decreasing. Thus, insufficient hardening of the ultraviolet curable resin 2 at this part is prevented. As a result, although not particularly shown in the drawings, the resin surface shape difference is improved near the periphery of the optically effective portion 11 in the composite lens. Therefore, it can be assumed that the thickness of the ultraviolet curable resin 2 is close to the designed value.

(2) The embossed surface 14 is annular and surrounds the optically effective portion 11. Thus, the ultraviolet light diffused by the embossed surface 14 reaches parts near the entire periphery of the optically effective portion 11.

(3) The advantages described above are obtained just by forming the embossed surface 14 in the flange 12. The embossed surface 14 can be formed at the same time as when injection molding the plastic lens 1. Alternatively, the embossed surface 14 may be formed by using a chemical agent after the injection molding to cause erosion in the surface of the plastic lens 1. This simplifies production of the composite lens and lowers costs.

### Third Embodiment

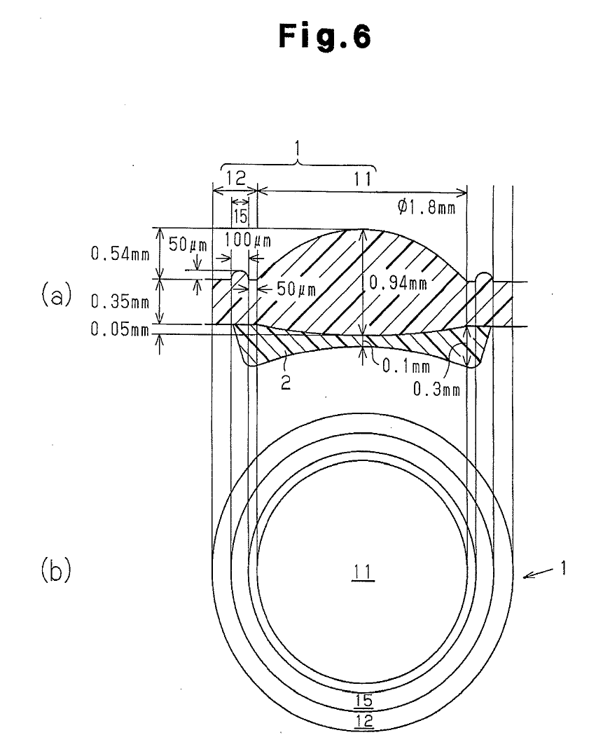

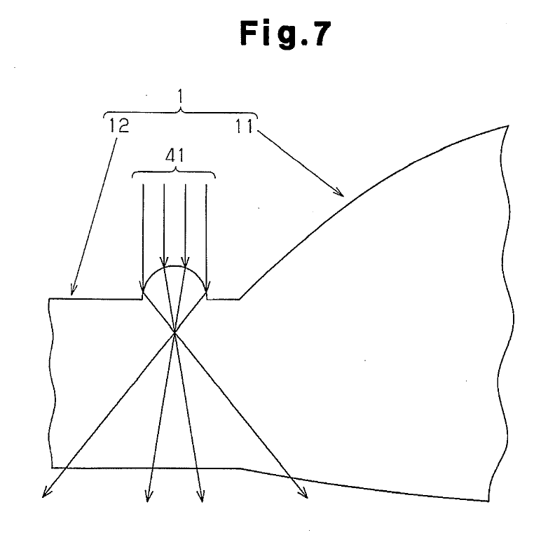

A composite lens according to a third embodiment of the present invention will now be discussed with reference to FIGS. 6(a), 6(b), and 7. The third embodiment differs from the first embodiment in the structure of the flange 12. Parts that are the same as the first embodiment will not be described.

As shown in FIG. 6(a) and 6(b), the flange 12 of the third embodiment includes an annular round projection 15, which surrounds the optically effective portion 11. The round projection 15 has a width of 100 μm and projects from the flange 12 to a height of 50 μm. As shown in FIG. 7, the round projection 15 first converges ultraviolet light and then diffuses the converged light so that the diffused light reaches the ultraviolet curable resin 2 contacting the optically effective portion 11. That is, the round projection 15 functions as a diffusion portion for diffusing the irradiated ultraviolet light toward the resin layer. Thus, the round projection 15 must have a large refractive index. The round projection 15 is formed by a mold when injection molding the plastic lens 1. When forming the round projection 15 with a mold, to sustain the strength of the mold, it is desirable that the round projection 15 be spaced outward by 50 μm or farther from the periphery of the optically effective portion 11.

The composite lens of the third embodiment has the advantages described below.

(1) The round projection 15 on the flange 12 first converges and then diffuses the irradiated ultraviolet light. As a result, some of the diffused ultraviolet light reaches the ultraviolet curable resin 2 contacting the optically effective portion 11. This increases the intensity of the ultraviolet light irradiating the ultraviolet curable resin 2 that is in contact with the optically effective portion 11 in comparison with the prior art. Accordingly, the intensity of the ultraviolet light near the periphery of the optically effective portion 11 is prevented from decreasing. Thus, insufficient hardening of the ultraviolet curable resin 2 at this part is prevented. As a result, although not particularly shown in the drawings, the resin surface shape difference is improved near the periphery of the optically effective portion 11 in the composite lens. Therefore, it can be assumed that the thickness of the ultraviolet curable resin 2 is close to the designed value.

(2) The round projection 15 is annular and surrounds the optically effective portion 11. Thus, the ultraviolet light diffused by the round projection 15 reaches parts near the entire periphery of the optically effective portion 11.

(3) The advantages described above are obtained just by forming the round projection 15 on the flange 12. The round projection 15 can be formed at the same time as when injection molding the plastic lens 1. This simplifies production of the composite lens and lowers costs.

### Fourth Embodiment

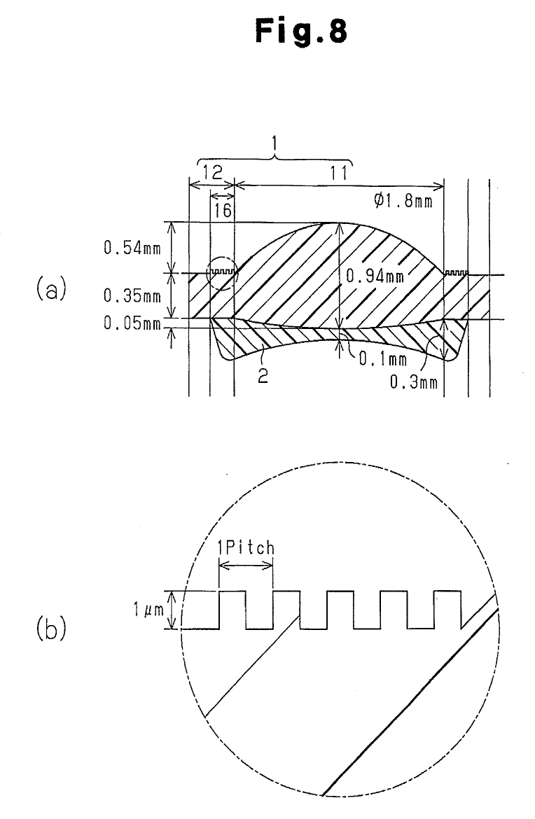

A composite lens according to a fourth embodiment of the present invention will now be discussed with reference to FIGS. 8(a) and 8(b). The fourth embodiment differs from the first embodiment in the structure of the flange 12. Parts that are the same as the first embodiment will not be described.

As shown in FIGS. 8(a) and 8(b), the flange 12 of the fourth embodiment 12 includes an annular diffraction grating 16, which surrounds the optically effective portion 11. The diffraction grating 16 functions as a diffusion portion for diffusing the irradiated ultraviolet light toward the resin layer. The diffraction grating 16 has a width of 200 μm and a grating spacing (pitch) of 1.33 μm. To direct ultraviolet light toward a region of the ultraviolet curable resin 2 where hardening is insufficient, the diffraction grating 16 must refract ultraviolet light within a range of refractive angle θ=8°˜15°. Accordingly, the diffraction grating 16 is formed based on the relationship of the equation shown below.

n·sinθ=λ/P (1)

In the equation, n represents the refractive index, θ represents the refractive angle, λ represents the wavelength, and P represents the diffraction grating pitch. In a state represented by n=1, λ=365 nm, and θ=8°˜15°, it is required that P=1.0˜1.7 μm be satisfied. In the fourth embodiment, the pitch P of the diffraction grating 16 is 1.33 μm and thus satisfies the above requirement. The diffraction grating 16 is formed by a mold when injection molding the plastic lens 1.

The composite lens of the fourth embodiment has the advantages described below.

(1) The diffraction grating 16 of the flange 12 refracts the irradiated ultraviolet light. As a result, some of the diffused ultraviolet light reaches the ultraviolet curable resin 2 contacting the optically effective portion 11. This increases the intensity of the ultraviolet light irradiating the ultraviolet curable resin 2 that is in contact with the optically effective portion 11 in comparison with the prior art. Accordingly, the intensity of the ultraviolet light near the periphery of the optically effective portion 11 is prevented from decreasing. Thus, insufficient hardening of the ultraviolet curable resin 2 at this part is prevented. As a result, although not particularly shown in the drawings, the resin surface shape difference is improved near the periphery of the optically effective portion 11 in the composite lens. Therefore, it can be assumed that the thickness of the ultraviolet curable resin 2 is close to the designed value.

(2) The diffraction grating 16 is annular and surrounds the optically effective portion 11. Thus, the ultraviolet light diffused by the diffraction grating 16 reaches parts near the entire periphery of the optically effective portion 11.

(3) The advantages described above are obtained just by forming the diffraction grating 16 on the flange 12. The diffraction grating 16 can be formed at the same time as when injection molding the plastic lens 1. This simplifies production of the composite lens and lowers costs.

It should be apparent to those skilled in the art that the present invention may be embodied in many other specific forms without departing from the spirit or scope of the invention. Particularly, it should be understood that the present invention may be embodied in the following forms.

In the first to fourth embodiments, the diffusion portion continuously surrounds the entire optically effective portion 11. However, as long as the ultraviolet curable resin 2 can be sufficiently hardened, the diffusion portion may be formed in a non-continuous manner on the flange 12. This would simplify production of the composite lens and increase the strength of the lens.

The diffusion portion for diffusing the ultraviolet light is not limited to the round groove 13, the embossed surface 14, the round projection 15, or the diffraction grating 16 as in the first to fourth embodiments.

The present examples and embodiments are to be considered as illustrative and not restrictive, and the invention is not to be limited to the details given herein, but may be modified within the scope and equivalence of the appended claims.

What is claimed is:

1. A composite lens comprising:
a plastic lens including an optically effective portion and a flange surrounding the optically effective portion; and
a resin layer formed from an ultraviolet curable resin and arranged in contact with the optically effective portion;
wherein the flange includes a diffusion portion which diffuses ultraviolet light irradiating the plastic lens toward the resin layer through the plastic lens.

2. The composite lens according to claim 1, wherein the diffusion portion is a groove surrounding the optically effective portion.

3. The composite lens according to claim 1, wherein the diffusion portion is an embossed surface surrounding the optically effective portion.

4. The composite lens according to claim 1, wherein the diffusion portion is a projection surrounding the optically effective portion.

5. The composite lens according to claim 1, wherein the diffusion portion is a diffraction grating surrounding the optically effective portion.
